(19) United States
(12) Patent Application Publication
(10) Pub. No.: US 2026/0192316 A1
(43) Pub. Date: Jul. 9, 2026

(54) UNIT FOR UPRIGHT AND INVERTED ATTITUDES

(71) Applicant: YOSHINO KOGYOSHO CO., LTD., Tokyo (JP)

(72) Inventor: Kotaro FUJIWARA, Tokyo (JP)

(73) Assignee: YOSHINO KOGYOSHO CO., LTD., Tokyo (JP)

(21) Appl. No.: 19/133,812

(22) PCT Filed: Nov. 30, 2023
(86) PCT No.: PCT/JP2023/042973

§ 371 Date: May 29, 2025

(30) Foreign Application Priority Data
Nov. 30, 2022 (JP) 2022-191663
Feb. 28, 2023 (JP) 2023-029599

(51) Int. Cl. B05B 11/10

(52) U.S. Cl. CPC B05B 11/1071; B05B 11/1011; B05B 11/1047

(57) ABSTRACT

A unit is provided for upright and inverted attitudes including an upright-attitude inlet, inverted-attitude inlet, relay port, a first and second switching valve, and at least one escape recess of an escape recess configured to allow second switching valve to enter therein and separate second switching valve from first path of a content liquid from upright-attitude inlet toward relay port on a side opposite to an inverted-attitude valve seat and in a direction crossing an opening direction of upright-attitude inlet during an upright attitude of a discharge device, and an escape recess configured to allow first switching valve to enter therein and separate first switching valve from a second path of content liquid from inverted-attitude inlet toward relay port on a side opposite to an upright-attitude valve seat and in a direction crossing an opening direction of inverted-attitude inlet during an inverted attitude of discharge device.

### TECHNICAL FIELD

The present invention relates to a unit for upright and inverted attitudes.

Priority is claimed on Japanese Patent Application No. 2022-191663, filed Nov. 30, 2022, and Japanese Patent Application No. 2023-029599, filed Feb. 28, 2023, the contents of which are incorporated herein by reference.

### BACKGROUND ART

As a unit for upright and inverted attitudes attached to a cylinder part of a discharge device, there is known a configuration including an upright-attitude inlet having a content liquid inlet of a cylinder part into which a content liquid in a container main body can be introduced during the upright attitude of the discharge device, an inverted-attitude inlet having a content liquid inlet into which a content liquid in the container main body can be introduced during the inverted attitude of the discharge device, a relay port able to communicate with the content liquid inlet, the upright-attitude inlet, and the inverted-attitude inlet, a first switching valve abutting an upright-attitude valve seat and configured to cut off communication between the inverted-attitude inlet and the relay port during the upright attitude of the discharge device, and a second switching valve abutting an inverted-attitude valve seat and configured to cut off communication between the upright-attitude inlet and the relay port during the inverted attitude of the discharge device.

In the unit for upright and inverted attitudes, the inside of the container main body and the content liquid inlet of the cylinder part are communicating with respect to each other through the upright-attitude inlet and the relay port during the upright attitude of the discharge device, and the inside of the container main body and the content liquid inlet are communicating with respect to each other through the inverted-attitude inlet and the relay port during the inverted attitude of the discharge device.

### CITATION LIST

### Patent Document

Patent Document 1: Japanese Unexamined Patent Application, First Publication No. 2017-47355

### SUMMARY OF INVENTION

### Technical Problem

In the unit for upright and inverted attitudes, when the content liquid in the container main body is introduced into the content liquid inlet of the cylinder part during the upright attitude of the discharge device, the second switching valve approaches the inverted-attitude valve seat on the liquid flow of the content liquid, and decompression in the cylinder part is exerted on the second switching valve through the relay port. Accordingly, the second switching valve may be pressed against the inverted-attitude valve seat.

Meanwhile, when the content liquid in the container main body is introduced into the content liquid inlet during the inverted attitude of the discharge device, the first switching valve approaches the upright-attitude valve seat on the liquid flow of the content liquid, and the decompression in the cylinder part is exerted on the first switching valve through the relay port. Accordingly, the first switching valve may be pressed against the upright-attitude valve seat.

For these reasons, it may not be possible to smoothly introduce the content liquid in the container main body into the cylinder part.

The present invention is directed to providing a unit for upright and inverted attitudes capable of smoothly introducing a content liquid in a container main body into a cylinder part.

### Solution to Problem

A first aspect of the present invention is a unit for upright and inverted attitudes attached to a cylinder part of a discharge device, the unit for upright and inverted attitudes including: an upright-attitude inlet into which a content liquid in a container main body is able to be introduced into a content liquid inlet of the cylinder part during an upright attitude of the discharge device; an inverted-attitude inlet into which the content liquid in the container main body is able to be introduced into the content liquid inlet during an inverted attitude of the discharge device; a relay port that is able to communicate with the content liquid inlet, the upright-attitude inlet, and the inverted-attitude inlet; a first switching valve abutting an upright-attitude valve seat and configured to cut off communication between the inverted-attitude inlet and the relay port during the upright attitude of the discharge device; a second switching valve abutting an inverted-attitude valve seat and configured to cut off communication between the upright-attitude inlet and the relay port during the inverted attitude of the discharge device; and at least one escape recess of an escape recess configured to allow the second switching valve to enter therein and separate the second switching valve from a first path of the content liquid from the upright-attitude inlet toward the relay port on a side opposite to the inverted-attitude valve seat and in a direction crossing an opening direction of the upright-attitude inlet during the upright attitude of the discharge device, and an escape recess configured to allow the first switching valve to enter therein and separate the first switching valve from a second path of the content liquid from the inverted-attitude inlet toward the relay port on a side opposite to the upright-attitude valve seat and in a direction crossing the opening direction of the inverted-attitude inlet during the inverted attitude of the discharge device.

In this case, the unit for upright and inverted attitudes includes at least one escape recess of the escape recess configured to allow the second switching valve to enter therein and separate the second switching valve from the first path of the content liquid from the upright-attitude inlet toward the relay port on the side opposite to the inverted-attitude valve seat and in the direction crossing an opening direction of the upright-attitude inlet during the upright attitude of the discharge device, and the escape recess configured to allow the first switching valve to enter therein and separate the first switching valve from the second path of the content liquid from the inverted-attitude inlet toward the relay port on the side opposite to the upright-attitude valve seat and in the direction crossing the opening direction of the inverted-attitude inlet during the inverted attitude of the discharge device. Accordingly, when the content liquid in the container main body is introduced into the content liquid inlet of the cylinder part, it is possible to do at least one of the preventing the content liquid flowing through the first path from coming into contact with the second switching valve, the second switching valve from riding on a liquid flow of the content liquid and approaching the inverted-attitude valve seat, during the upright attitude of the discharge device, and the preventing the content liquid flowing through the second path from coming into contact with the first switching valve, the first switching valve from riding the liquid flow of the content liquid and approaching the upright-attitude valve seat, during the inverted attitude of the discharge device.

Accordingly, when the content liquid is introduced into the content liquid inlet of the cylinder part, it is possible to do at least one of the preventing the second switching valve from being pressed against the inverted-attitude valve seat due to decompression in the cylinder part exerted through the relay port during the upright attitude of the discharge device, and the preventing the first switching valve from being pressed against the upright-attitude valve seat due to decompression in the cylinder part exerted through the relay port during the inverted attitude of the discharge device, and it is possible to smoothly introduce the content liquid in the container main body into the cylinder part.

A second aspect of the present invention is the unit for upright and inverted attitudes of the first aspect, further comprising a channel forming member provided with a common channel that communicates with the content liquid inlet and the relay port, wherein the channel forming member includes a topped tubular portion extending in an upward/downward direction, the inverted-attitude inlet and the relay port are communicating with respect to each other through an inside of the topped tubular portion, the inverted-attitude inlet is formed in a portion of a circumferential wall of the topped tubular portion located below an upper end portion, and a portion in the inside of the topped tubular portion and located above the inverted-attitude inlet being the escape recess into which the first switching valve enters during the inverted attitude of the discharge device.

In this case, since the channel forming member provided with the common channel that communicates with the content liquid inlet and the relay port includes the topped tubular portion and the portion in the topped tubular portion located above the inverted-attitude inlet is the escape recess configured to allow the first switching valve to enter therein during the inverted attitude of the discharge device, it is possible to obtain the unit for upright and inverted attitudes capable of smoothly introducing the content liquid in the container main body into the cylinder part while minimizing structural complexity.

A third aspect of the present invention is the unit for upright and inverted attitudes according to the first aspect or the second aspect, further comprising at least one prevention part of a prevention part configured to prevent the second switching valve from entering the first path during the upright attitude of the discharge device, and a prevention part configured to prevent the first switching valve from entering the second path during the inverted attitude of the discharge device.

In this case, the unit for upright and inverted attitudes includes at least one prevention part of the prevention part configured to prevent the second switching valve from entering the first path during the upright attitude of the discharge device, and the prevention part configured to prevent the first switching valve from entering the second path during the inverted attitude of the discharge device. Accordingly, when the content liquid in the container main body in introduced into the content liquid inlet, it is possible to do at least one of the preventing the content liquid flowing through the first path from coming into contact with the second switching valve, the second switching valve from riding the liquid flow of the content liquid and approaching the inverted-attitude valve seat, during the upright attitude of the discharge device, and the preventing the content liquid flowing through the second path from coming into contact with the first switching valve, the first switching valve from riding the liquid flow of the content liquid and approaching the upright-attitude valve seat, during the inverted attitude of the discharge device.

Accordingly, when the content liquid is introduced into the content liquid inlet, it is possible to do at least one of the preventing the second switching valve from being pressed against the inverted-attitude valve seat due to decompression in the cylinder part exerted through the relay port during the upright attitude of the discharge device, and the preventing the first switching valve from being pressed against the upright-attitude valve seat due to decompression in the cylinder part exerted through the relay port during the inverted attitude of the discharge device, and it is possible to smoothly introduce the content liquid in the container main body into the cylinder part.

A fourth aspect of the present invention is the unit for upright and inverted attitudes according to the first aspect or the second aspect, wherein at least one inlet of the upright-attitude inlet and the inverted-attitude inlet is provided with an introduction protrusion, the introduction protrusion extending along a path for a content liquid from the at least one inlet toward the relay port, and having an introduction surface facing inward of the at least one inlet in an opening direction of the at least one inlet.

In this case, the introduction protrusion is provided on at least one inlet of the upright-attitude inlet and the inverted-attitude inlet. Accordingly, when the content liquid passes through the inlet, the content liquid flows along the introduction surface and is guided to the relay port, which can prevent it from flowing into the escape recess, and the liquid flow of the content liquid that passes through the inlet and flows into the escape recess can prevent the switching valve in the escape recess from floating up toward the relay port. Accordingly, when the content liquid is introduced into the content liquid inlet of the cylinder part, it is possible to reliably do at least one of the preventing the second switching valve from being pressed against the inverted-attitude valve seat due to decompression in the cylinder part exerted through the relay port during the upright attitude of the discharge device, and the preventing the first switching valve from being pressed against the upright-attitude valve seat due to decompression in the cylinder part exerted through the relay port during the inverted attitude of the discharge device.

A fifth aspect of the present invention is the unit for upright and inverted attitudes according to the second aspect, wherein a tip edge of the introduction protrusion facing the relay port along the path extends in a direction away from the relay port as it goes toward an outside of the at least one inlet in the opening direction of the at least one inlet provided with the introduction protrusion when seen in a longitudinal cross-sectional view, a tilt angle of the tip edge of the introduction protrusion is 15° or more and 40° or less when seen in a longitudinal cross-sectional view, the introduction protrusion is located on the outside of the at least one inlet in the opening direction with respect to a surface facing a surface provided with the introduction protrusion, in the at least one inlet provided with the introduction protrusion, and an end portion of the facing surface of the at least one inlet provided with the introduction protrusion, the end portion being on a side of the introduction protrusion in the opening direction, is located on an extension line of the tip edge of the introduction protrusion when seen in a longitudinal cross-sectional view.

In this case, the introduction protrusion can be easily molded by cutting without complicating the structure of the molding tool.

### Advantageous Effects of Invention

According to the present invention, it is possible to smoothly introduce a content liquid in a container main body into a cylinder part.

### BRIEF DESCRIPTION OF DRAWINGS

FIG. 1 A longitudinal cross-sectional view of a discharge device having a unit for upright and inverted attitudes shown as a first embodiment according to the present invention.

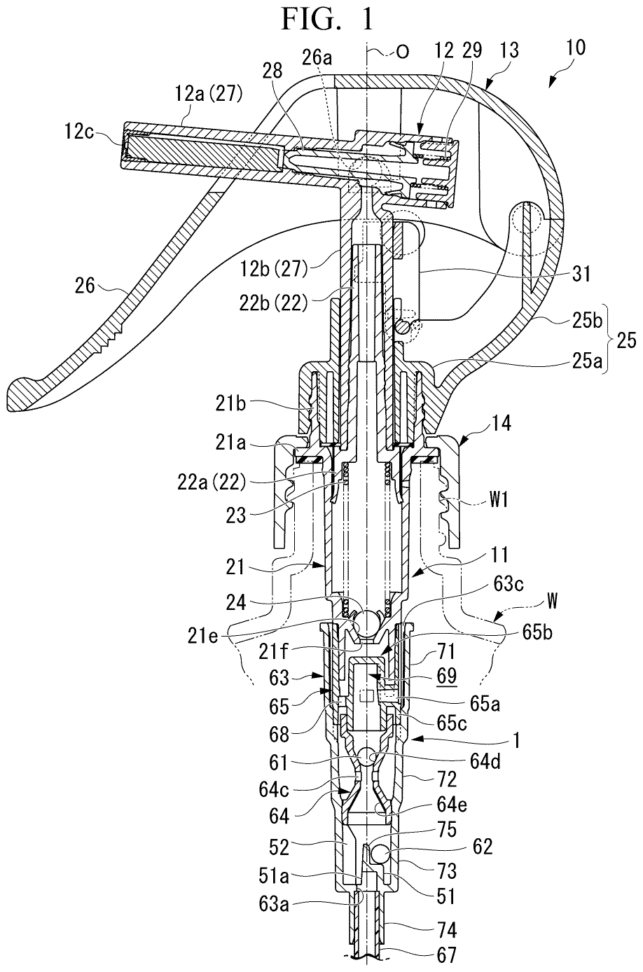

FIG. 2 An enlarged view of the unit for upright and inverted attitudes in FIG. 1.

FIG. 3 A cross-sectional view along line III-III in FIG. 2.

FIG. 4 A view showing the discharge device during the inverted attitude in FIG. 2.

FIG. 5A An enlarged view of a unit for upright and inverted attitudes of a second embodiment according to the present invention.

FIG. 5B A view showing a discharge device during the inverted attitude in FIG. 5A.

FIG. 6A An enlarged view of a unit for upright and inverted attitudes of a third embodiment according to the present invention.

FIG. 6B A view showing a discharge device in FIG. 6A during the inverted attitude.

### DESCRIPTION OF EMBODIMENTS

Hereinafter, a unit for upright and inverted attitudes according to a first embodiment of the present invention will be described with reference to the accompanying drawings.

A unit 1 for upright and inverted attitudes constitutes a part of a discharge device 10 including a pump 11, a discharge head 12, a pressing member 13, and a mounting cap 14.

First, the pump 11, the discharge head 12, the pressing member 13, and the mounting cap 14 will be described.

The pump 11 includes a cylinder part 21, a piston part 22, a first biasing member 23, and a lower valve body 24, a content liquid in a container main body W is introduced into the cylinder part 21 through a content liquid inlet 21f by a decrease in an internal pressure due to an increase in an internal volume of the cylinder part 21, and the content liquid in the cylinder part 21 is sent to the discharge head 12 by an increase in an internal pressure due to a decrease in an internal volume of the cylinder part 21.

Each of the cylinder part 21, the piston part 22, and the first biasing member 23 is formed in a tubular shape and is arranged coaxially with a common shaft.

Hereinafter, the common shaft is referred to as an axis O, a side of the discharge head 12 in an axis O direction is referred to as an upper side, a side of the unit 1 for upright and inverted attitudes in the axis O direction is referred to as a lower side, and a direction along the axis O is referred to as an upward/downward direction. A direction crossing the axis O when seen in the upward/downward direction is referred to as a radial direction, and a direction around the axis O when seen in the upward/downward direction is referred to as a circumferential direction.

The cylinder part 21 is inserted into a mouth portion W1 of the container main body W in which a content liquid is accommodated. A flange portion 21a protruding outward in the radial direction is formed on the cylinder part 21. The flange portion 21a is placed on an upper end opening edge of the mouth portion W1 via a packing. A first connecting tube portion 21b protruding upward is formed on the flange portion 21a. The first connecting tube portion 21b is disposed coaxially with the axis O.

The piston part 22 includes a topped tubular sliding portion 22a having an annular top wall, and a tube portion 22b extending upward from an inner circumferential edge portion of a top wall of the sliding portion 22a. The sliding portion 22a is vertically slidably fitted into the cylinder part 21. The tube portion 22b is inserted into the first connecting tube portion 21b, and an upper end portion of the tube portion 22b protrudes upward from the first connecting tube portion 21b.

An upper end portion of the first biasing member 23 is inserted into the sliding portion 22a, and abuts a lower surface of the top wall of the sliding portion 22a. A lower end portion of the first biasing member 23 abuts a stepped portion formed on an inner circumferential surface of the cylinder part 21 and facing upward.

The lower valve body 24 is, for example, a ball valve, and is provided in a lower end portion of the cylinder part 21. A valve seat portion 21e protruding inward in the radial direction and having a diameter reduced downward is formed on an inner circumferential surface of the lower end portion of the cylinder part 21. A lower end opening of the valve seat portion 21e is the content liquid inlet 21f through which the content liquid in the container main body W is introduced into the cylinder part 21. The lower valve body 24 is mounted upwardly and separably on the upper surface of the valve seat portion 21e. The lower valve body 24 is a check valve configured to cut off communication between the inside of the container main body W and the inside of the cylinder part 21 during pressurization in the cylinder part 21 and allow communication between the inside of the container main body W and the inside of the cylinder part 21 during decompression in the cylinder part 21.

The mounting cap 14 is mounted on the mouth portion W1. The mounting cap 14 is formed in a topped tubular shape having an annular top wall, and the first connecting tube portion 21b is inserted into the top wall. The flange portion 21a is sandwiched and fixed between the lower surface of the top wall and the upper end opening edge of the mouth portion W1 in the upward/downward direction.

The pressing member 13 includes a support portion 25, and a lever portion 26.

The support portion 25 includes a topped tubular second connecting tube portion 25a fitted onto the first connecting tube portion 21b, and a protrusion portion 25b protruding upward from the second connecting tube portion 25a. A top wall of the second connecting tube portion 25a is formed in an annular shape, the tube portion 22b of the piston part 22 is inserted thereinside, and an upper end portion of the tube portion 22b protrudes upward from the second connecting tube portion 25a. The protrusion portion 25b is separated from the axis O in the radial direction.

Hereinafter, in the radial direction, a side where the protrusion portion 25b is separated from the axis O is referred to as a rear side, and a side opposite thereto is referred to as a front side.

A rear portion of the lever portion 26 extends forward from the upper end portion of the protrusion portion 25b and straddles the axis O in the forward/rearward direction, and a front portion of the lever portion 26 extends downward from a front end portion of the rear portion of the lever portion 26. The lever portion 26 is provided rotatably around the upper end portion of the protrusion portion 25b in the upward/downward direction. The lever portion 26 has an engagement portion 26a engaged with the discharge head 12. As the lever portion 26 rotates downward around the upper end portion of the protrusion portion 25b, the engagement portion 26a presses down on the discharge head 12.

A restriction member 31 movably provided between a restriction position where downward rotation of the lever portion 26 is restricted and a permitted position where downward rotation of the lever portion 26 is permitted is attached to the support portion 25.

The discharge head 12 includes a main body portion 27, an accumulator valve 28, and a second biasing member 29.

The main body portion 27 includes a horizontal tube 12a extending in the radial direction, and a vertical tube 12b extending downward from the horizontal tube 12a. The horizontal tube 12a extends in the forward/rearward direction and passes through the front portion of the lever portion 26 in the forward/rearward direction. A discharge hole 12c that opens forward is formed in a front end portion of the horizontal tube 12a. The vertical tube 12b extends downward from a rear portion of the horizontal tube 12a. The vertical tube 12b is fitted onto the tube portion 22b of the piston part 22.

The accumulator valve 28 is provided in the horizontal tube 12a, and cuts off communication between the inside of the vertical tube 12b and the discharge hole 12c. The accumulator valve 28 is provided within the rear portion of the horizontal tube 12a so as to be movable back and forth, and is biased forward by the second biasing member 29. When an internal pressure of the rear portion of the horizontal tube 12a exceeds a predetermined value, as the accumulator valve 28 moves backward against the biasing force of the second biasing member 29, communication is established between the inside of the vertical tube 12b and the discharge hole 12c, and the content liquid is discharged from the discharge hole 12c.

Next, the unit 1 for upright and inverted attitudes will be described.

The unit 1 for upright and inverted attitudes is attached to the cylinder part 21. The unit 1 for upright and inverted attitudes includes a first switching valve 61, a second switching valve 62, an outer tube member 63, an inner tube member 64, and a channel forming member 65. The outer tube member 63 and the inner tube member 64 are arranged coaxially with the axis O.

The channel forming member 65 has an inverted-attitude inlet 65a through which the content liquid in the container main body W can be introduced into the content liquid inlet 21f of the cylinder part 21 during an inverted attitude of the discharge device 10. The channel forming member 65 is formed in a bottomed tubular shape and fitted onto a lower end portion of the cylinder part 21. A seal tube portion 65c protruding downward is formed on an outer circumferential edge portion of a bottom wall portion of the channel forming member 65.

The outer tube member 63 is fitted onto the cylinder part 21 via the channel forming member 65. The outer tube member 63 has an upright-attitude inlet 63a through which the content liquid in the container main body W can be introduced into the content liquid inlet 21f of the cylinder part 21 during an upright attitude of the discharge device 10, and an intake hole 63c through which the content liquid in the container main body W can be introduced into the inverted-attitude inlet 65a during the inverted attitude of the discharge device 10.

The upright-attitude inlet 63a and the intake hole 63c open in the container main body W. The intake hole 63c and the inverted-attitude inlet 65a are located above the upright-attitude inlet 63a during the upright attitude of the discharge device 10.

The outer tube member 63 is formed in a multi-stage tubular shape having a diameter gradually decreased downward. The outer tube member 63 is constituted by, from top to bottom, a first outer tube portion 71, a second outer tube portion 72, a third outer tube portion 73, and a fourth outer tube portion 74, lined up in this order.

The first outer tube portion 71 surrounds the outer circumferential surface of the channel forming member 65 with a gap in the radial direction. An annular gap extending in the circumferential direction is provided between the outer circumferential surface of the channel forming member 65 and the inner circumferential surface of the first outer tube portion 71. The inverted-attitude inlet 65a opens in the gap. An upper end opening of the first outer tube portion 71 is the intake hole 63c. The seal tube portion 65c of the channel forming member 65 is closely fitted into the lower end portion of the first outer tube portion 71.

Further, the first outer tube portion 71 may have only a lower end portion fitted onto the seal tube portion 65c, and no portion located above the lower end portion and no intake hole 63c, with the inverted-attitude inlet 65a opening into the container main body W.

A relay port 64c of the inner tube member 64, which will be described below, opens in the second outer tube portion 72.

A lower end portion of the inner tube member 64 is closely fitted into the upper end portion of the third outer tube portion 73. A lower end opening of the third outer tube portion 73 is the upright-attitude inlet 63a that opens in the upward/downward direction. The second switching valve 62 is movably accommodated in the third outer tube portion 73. The second switching valve 62 is, for example, a ball valve.

An upper end portion of a suction tube 67 is fitted into the fourth outer tube portion 74. A lower end portion of the suction tube 67 is located at the bottom portion of the container main body W. The upright-attitude inlet 63a is in communication with the inside of the container main body W through the suction tube 67. Further, a configuration may be adopted in which the fourth outer tube portion 74 is not provided and the upper end portion of the suction tube 67 is connected to, for example, the third outer tube portion 73.

The inner tube member 64 has a lower end opening 64a in communication with the upright-attitude inlet 63a, an upper end opening 64b in communication with the inverted-attitude inlet 65a, and the relay port 64c that can communicate with the content liquid inlet 21f, the upright-attitude inlet 63a, and the inverted-attitude inlet 65a. The relay port 64c is in communication with each of the content liquid inlet 21f, the upright-attitude inlet 63a, and the inverted-attitude inlet 65a through different flow paths.

The inner tube member 64 is formed in a gourd shape with the intermediate portion in the upward/downward direction being constricted inward in the radial direction. An upper end portion of the inner tube member 64 is connected to a bottom wall portion of the channel forming member 65. The inner tube member 64 is constituted by, from top to bottom, a first inner tube portion 76, a second inner tube portion 77, and a third inner tube portion 78, lined up in this order.

The upper end opening of the first inner tube portion 76 is the upper end opening 64b of the inner tube member 64. An upright-attitude valve seat 64d extending inward in the radial direction as it goes downward is formed on an inner circumferential surface of a lower portion of the first inner tube portion 76.

The first switching valve 61 enters a second path L2, which will be described below, during the upright attitude of the discharge device 10, and abuts against the upright-attitude valve seat 64d, cutting off communication between the inverted-attitude inlet 65a and the relay port 64c. The first switching valve 61 is disposed above the upright-attitude valve seat 64d. The first switching valve 61 is, for example, a ball valve, and is abutting the upright-attitude valve seat 64d to be separable upward.

The second inner tube portion 77 configures a constricted portion of the inner tube member 64. The plurality of relay ports 64c passing in the radial direction are formed in the second inner tube portion 77 at intervals in the circumferential direction.

A lower end opening of the third inner tube portion 78 is the lower end opening 64a of the inner tube member 64. A lower end portion of the third inner tube portion 78 is fitted into an upper end portion of the third outer tube portion 73 of the outer tube member 63. An inverted-attitude valve seat 64e extending inward in the radial direction as it goes upward is formed on an inner circumferential surface of the upper portion of the third inner tube portion 78.

The second switching valve 62 is disposed below the inverted-attitude valve seat 64e. The second switching valve 62 is disposed to be able to abut the inverted-attitude valve seat 64e from below. The second switching valve 62 enters a first path L1, which will be described below, during the inverted attitude of the discharge device 10, and abuts the inverted-attitude valve seat 64e, cutting off communication between the upright-attitude inlet 63a and the relay port 64c.

An anti-sticking portion 64f configured to prevent sticking of the second switching valve 62 is formed on the inverted-attitude valve seat 64e. The anti-sticking portion 64f can be, for example, a groove or rib provided radially on the inverted-attitude valve seat 64e, but may be changed as appropriate to any irregularity that can prevent sticking of the second switching valve 62. The anti-sticking portion 64f does not need to be formed on the inverted-attitude valve seat 64e. In this case, the inner tube member 64 may be formed in a vertically symmetrical shape, and when the discharge device 10 is in the inverted attitude, the sealability between the second switching valve 62 and the inverted-attitude valve seat 64e is improved, and communication between the upright-attitude inlet 63a and the relay port 64c can be reliably cut off.

A plug (topped tubular portion) 65b and a common channel 68 are formed in a bottom wall portion of the channel forming member 65.

The plug 65b is provided radially inward from the seal tube portion 65c. The plug 65b protrudes on both sides in the upward/downward direction from the bottom wall portion of the channel forming member 65, and a part of the plug 65b that protrudes downward from the bottom wall portion of the channel forming member 65 is fitted into the upper end opening 64b of the inner tube member 64. The plug 65b is formed in a topped tubular shape extending in the upward/downward direction. The inverted-attitude inlet 65a is formed in a portion of the circumferential wall of the plug 65b that is located below the upper end portion. The inverted-attitude inlet 65a extends in the radial direction, penetrates a bottom wall portion of the channel forming member 65 in the radial direction, opens to the inner circumferential surface of the plug 65b and the outer circumferential surface of the channel forming member 65, and communicates with the intake hole 63c.

The common channel 68 is in communication with the content liquid inlet 21f of the cylinder part 21 and the relay port 64c. The common channel 68 penetrates in the upward/downward direction through the bottom wall portion of the channel forming member 65 located between the plug 65b and the seal tube portion 65c, and opens into the channel forming member 65. The common channel 68 opens toward the upper end opening edge of the first inner tube portion 76.

Here, an upper end portion of the first inner tube portion 76 is inserted into the seal tube portion 65c. An annular gap extending in the circumferential direction is provided between the inner circumferential surface of the seal tube portion 65c and the outer circumferential surface of the first inner tube portion 76. A lower surface of the bottom wall portion of the channel forming member 65 is separated upward from the upper end opening edge of the first inner tube portion 76, and an annular gap between the inner circumferential surface of the seal tube portion 65c and the outer circumferential surface of the first inner tube portion 76 is in communication with the common channel 68.

Here, in the embodiment, there is provided at least one of a prevention part 75 configured to prevent the second switching valve 62 from entering the first path L1 through which the content liquid is directed toward the relay port 64c from the upright-attitude inlet 63a during the upright attitude of the discharge device 10, and a prevention part configured to prevent the first switching valve 61 from entering the second path L2 through which the content liquid is directed toward the relay port 64c from the inverted-attitude inlet 65a during the inverted attitude of the discharge device 10.

Further, the prevention part of the latter with respect to the first switching valve 61 is provided on the plug 65b.

In the example shown, a topped tubular covering portion 51 protruding upward and configured to cover the upright-attitude inlet 63a from above is formed on an opening circumferential edge portion of the upright-attitude inlet 63a in the inner surface of the outer tube member 63. A side opening 51a that opens in the radial direction and brings the upright-attitude inlet 63a and the inside of the third outer tube portion 73 in communication with each other is formed in a circumferential wall of the covering portion 51. The prevention part 75 with respect to the above-mentioned second switching valve 62 protrudes upward from the top wall of the covering portion 51.

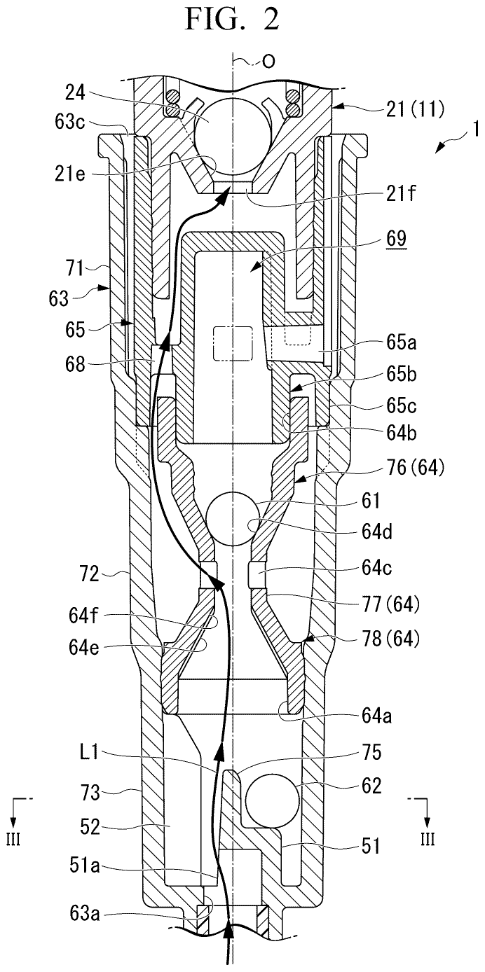

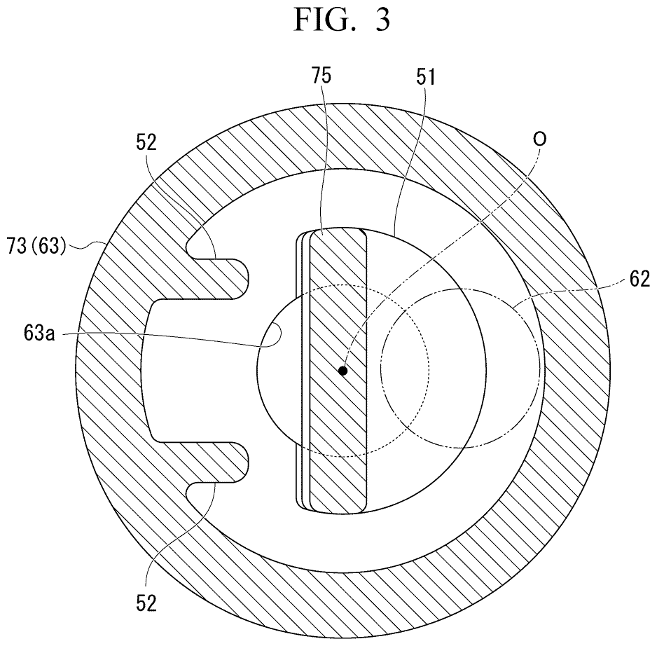

A protrusion amount of the prevention part 75 protruding upward from the top wall of the covering portion 51 is equal to an outer diameter of the second switching valve 62. As shown in FIG. 3, when seen in the upward/downward direction, the prevention part 75 is formed like a plate whose front surface faces the side where the side opening 51a is open in the radial direction. The prevention part 75 is located at an end portion of the top wall of the covering portion 51 at a side where the side opening 51a in the radial direction is open. As shown in FIG. 2, when seen in a longitudinal cross-sectional view in the upward/downward direction, a front surface of the prevention part 75 is located on the same straight line as the opening surface of the side opening 51a. Since the prevention part 75 is formed in a plate shape as described above, it is less likely to cause space constraints compared to, for example, a configuration in which it is formed in a cylindrical shape extending continuously around the entire circumference.

An interval between a part of the inner circumferential surface of the third outer tube portion 73 facing a back surface of the prevention part 75 in the radial direction and the back surface of the prevention part 75 is greater than an outer diameter of the second switching valve 62. An interval between a part of the inner circumferential surface of the third outer tube portion 73 facing an outer circumferential surface of the circumferential wall of the covering portion 51 in the radial direction and the outer circumferential surface of the circumferential wall of the covering portion 51 is smaller than the outer diameter of the second switching valve 62. The second switching valve 62 is located in a space surrounded by the back surface of the prevention part 75, the upper surface of the top wall of the covering portion 51 and the inner circumferential surface of the third outer tube portion 73, during the upright attitude of the discharge device 10.

An interval between a part of the inner circumferential surface of the third outer tube portion 73 facing the side opening 51a and the front surface of the prevention part 75 in the radial direction and the side opening 51a and the front surface of the prevention part 75 is greater than the outer diameter of the second switching valve 62.

A space between a part of the inner circumferential surface of the third outer tube portion 73 facing the side opening 51a and the front surface of the prevention part 75 in the radial direction and the side opening 51a and the front surface of the prevention part 75 is an inlet portion of the first path L1 through which the content liquid is directed toward the relay port 64c from the upright-attitude inlet 63a, and a guide portion 52 configured to guide the second switching valve 62 attempted to enter the inlet portion toward the back surface of the prevention part 75 during the upright attitude of the discharge device 10 is provided inside the third outer tube portion 73.

The guide portion 52 protrudes inward in the radial direction from a part of the inner circumferential surface of the third outer tube portion 73 facing the side opening 51a and the front surface of the prevention part 75 in the radial direction. The guide portion 52 extends upward from a lower end portion of the third outer tube portion 73. The upper end portion of the guide portion 52 is located above the upper end portion of the prevention part 75, and abuts against the lower end portion of the inner tube member 64 in the upward/downward direction. The upper end portion of the guide portion 52 extends outward in the radial direction as it goes upward. The guide portion 52 is formed in a plate shape with front and back surfaces facing in the circumferential direction. As shown in FIG. 3, the guide portion 52 is provided on each side of the inner circumferential surface of the third outer tube portion 73, sandwiching in the circumferential direction the central portion in the circumferential direction of the side opening 51a and the prevention part 75 and the portions that face each other in the radial direction.

Here, in the embodiment, there is provided at least one of an escape recess configured to allow the second switching valve 62 to enter thereinto and separate the second switching valve 62 from the first path L1 on a side opposite to the inverted-attitude valve seat 64e and in a direction crossing an opening direction of the upright-attitude inlet 63a during the upright attitude of the discharge device 10, and an escape recess 69 configured to allow the first switching valve 61 to enter thereinto and separate the first switching valve 61 from the second path L2 on a side opposite to the upright-attitude valve seat 64d and a direction crossing the opening direction of the inverted-attitude inlet 65a during the inverted attitude of the discharge device 10.

Further, it is possible to adopt a configuration in which, as the escape recess of the former with respect to the second switching valve 62, for example, in the inner circumferential surface of the third outer tube portion 73, an interval between the portion facing the outer circumferential surface of the circumferential wall of the covering portion 51 in the radial direction and the outer circumferential surface of the circumferential wall of the covering portion 51 is greater than the outer diameter of the second switching valve 62, and the gap portion is recessed below the upright-attitude inlet 63a.

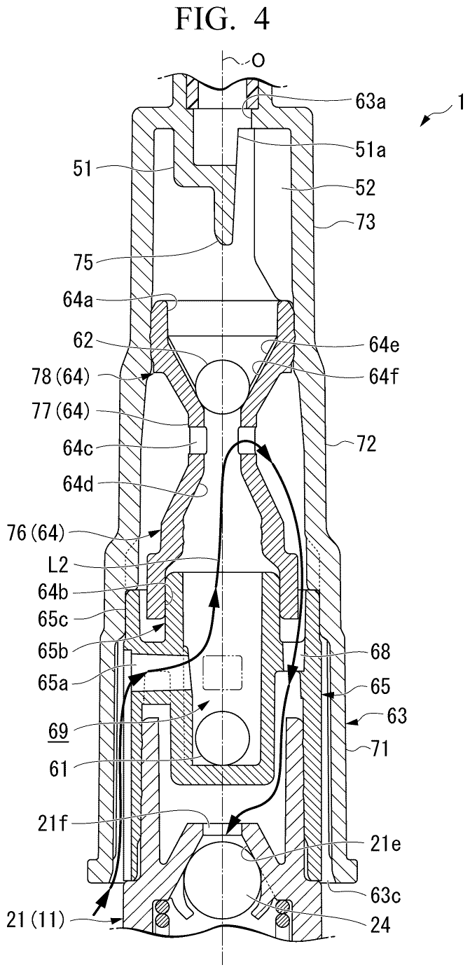

In the example shown, in the inside of the plug 65b, the portion located above the inverted-attitude inlet 65a is the escape recess 69 into which the first switching valve 61 enters during the inverted attitude of the discharge device 10. As shown in FIG. 4, the first switching valve 61 entering the escape recess 69 is separated from the second path L2 in a direction crossing the upward/downward direction, i.e., from the second path L2 in a direction crossing the opening direction (radial direction) of the inverted-attitude inlet 65a.

Next, an action of the discharge device 10 will be described.

When the lever portion 26 is rotated downward around the upper end portion of the protrusion portion 25b to push down the discharge head 12, the piston part 22 is pushed down together with the discharge head 12 against the biasing force of the first biasing member 23. Here, the sliding portion 22a of the piston part 22 slides downward on the inner circumferential surface of the cylinder part 21, reducing the internal volume of the cylinder part 21, thereby pressurizing the inside of the cylinder part 21. As the internal pressure in the cylinder part 21 increases, the lower valve body 24 in the cylinder part 21 comes into close contact with the valve seat portion 21e, cutting off communication between the inside of the cylinder part 21 and the inside of the container main body W. Accordingly, the content liquid pressurized in the cylinder part 21 rises inside the tube portion 22b of the piston part 22 and flows into the rear portion of the horizontal tube 12a through the vertical tube 12b of the discharge head 12, thereby pressurizing the rear portion of the horizontal tube 12a. Then, when the internal pressure in the rear portion of the horizontal tube 12a exceeds a predetermined value, the accumulator valve 28 moves rearward against the biasing force of the second biasing member 29, thereby communicating between the inside of the vertical tube 12b and the discharge hole 12c, and discharging the content liquid from the discharge hole 12c.

After that, when the discharge head 12 is released from the depressed state, the piston part 22 rises together with the discharge head 12 due to the upward biasing force of the first biasing member 23.

When the piston part 22 slides upward along the inner circumferential surface of the cylinder part 21, the space enclosed by the inner circumferential surface of the cylinder part 21 and the inner circumferential surface of the piston part 22 increases, causing decompression inside the cylinder part 21. Due to the reduction in the internal pressure of the cylinder part 21, the lower valve body 24 moves upward from the upper surface of the valve seat portion 21e, the content liquid inlet 21f is opened, and a main flow path from the content liquid inlet 21f to the relay port 64c becomes decompressed.

The main flow path includes a gap between the common channel 68, the lower surface of the bottom wall portion of the channel forming member 65 and the upper end opening edge of the first inner tube portion 76, a gap between the inner circumferential surface of the seal tube portion 65c and the outer circumferential surface of the first inner tube portion 76, a gap between the inner circumferential surface of the second outer tube portion 72 and the outer circumferential surface of the first inner tube portion 76, and a gap between the inner circumferential surface of the second outer tube portion 72 and the outer circumferential surface of the second inner tube portion 77, inside the channel forming member 65.

When the main flow path enters the decompression state, during the upright attitude of the discharge device 10, the first switching valve 61 is close to the upright-attitude valve seat 64d and communication between the inverted-attitude inlet 65a and the relay port 64c is cut off, so that the inside of the third inner tube portion 78 and the inside of the third outer tube portion 73 are decompressed through the relay port 64c and the inside of the second inner tube portion 77. Accordingly, the flow path for the upright attitude, which runs from the content liquid inlet 21f through the main flow path, the relay port 64c, the inside of the second inner tube portion 77, the inside of the third inner tube portion 78, the inside of the third outer tube portion 73, the upright-attitude inlet 63a, and the inside of the suction tube 67 to the inside of the container main body W, becomes decompressed, and the content liquid in the container main body W is sucked up into the cylinder part 21.

Here, the second switching valve 62 is separated from the first path L1 of the content liquid flowing from the upright-attitude inlet 63a to the relay port 64c by the prevention part 75, thereby preventing the content liquid flowing through the first path L1 from coming into contact with the second switching valve 62.

Meanwhile, during the inverted attitude of the discharge device 10, as shown in FIG. 4, the first switching valve 61 moves away from the upright-attitude valve seat 64d due to its own weight, establishing communication between the inverted-attitude inlet 65a and the relay port 64c, and the second switching valve 62 moves closely to the inverted-attitude valve seat 64e due to its own weight, cutting off communication between the upright-attitude inlet 63a and the relay port 64c. In this state, when the discharge head 12 moves back to its original position after discharging the content liquid, similar to during the upright attitude of the discharge device 10 described above, the lower valve body 24 moves away from the valve seat portion 21e, opening the content liquid inlet 21f and causing the main flow path from the content liquid inlet 21f to the relay port 64c to be in a decompressed state, and therefore, the flow path for the inverted attitude from the relay port 64c through the inverted-attitude inlet 65a to the intake hole 63c also becomes decompressed.

The flow path during the inverted attitude includes the inside of the second inner tube portion 77, the inside of the first inner tube portion 76, the inside of the plug 65b, the inverted-attitude inlet 65a, and a gap between the outer circumferential surface of the channel forming member 65 and the inner circumferential surface of the first outer tube portion 71.

When the flow path during the inverted attitude is in a decompression state, during the inverted attitude of the discharge device 10, the content liquid in the container main body W is introduced into the content liquid inlet 21f through the intake hole 63c, the flow path during the inverted attitude, the relay port 64c, and the main flow path.

During the inverted attitude of the discharge device 10, the first switching valve 61 enters the plug 65b, reaches the escape recess 69 in the plug 65b, and abuts the top wall of the plug 65b. Here, the first switching valve 61 is separated from the inverted-attitude inlet 65a in the upward/downward direction. Accordingly, the first switching valve 61 is separated from the second path L2 of the content liquid from the inverted-attitude inlet 65a toward the relay port 64c in the upward/downward direction, preventing the content liquid flowing through the second path L2 from coming into contact with the first switching valve 61.

As described above, according to the unit 1 for upright and inverted attitudes of the embodiment, there is provided at least one escape recess of the escape recess configured to allow the second switching valve 62 to enter thereinto and separate the second switching valve 62 from the first path L1 at the side opposite to the inverted-attitude valve seat 64e in the direction crossing the opening direction of the upright-attitude inlet 63a during the upright attitude of the discharge device 10, and the escape recess 69 configured to allow the first switching valve 61 to enter thereinto and separate the first switching valve 61 from the second path L2 at the side opposite to the upright-attitude valve seat 64d in the direction crossing the opening direction of the inverted-attitude inlet 65a during the inverted attitude of the discharge device 10. Therefore, when the content liquid in the container main body W is introduced into the content liquid inlet 21f, it is possible to do at least one of the preventing the content liquid flowing through the first path L1 from coming into contact with the second switching valve 62, the second switching valve 62 riding the liquid flow of the content liquid and approaching the inverted-attitude valve seat 64e, during the upright attitude of the discharge device 10, and the preventing the content liquid flowing through the second path L2 from coming into contact with the first switching valve 61, the first switching valve 61 riding the liquid flow of the content liquid and approaching the upright-attitude valve seat 64d, during the inverted attitude of the discharge device 10.

Accordingly, when the content liquid is introduced into the content liquid inlet 21f, it is possible to do at least one of the preventing the second switching valve 62 from being pressed against the inverted-attitude valve seat 64e due to decompression in the cylinder part 21 acting through the relay port 64c during the upright attitude of the discharge device 10, and the preventing the first switching valve 61 from being pressed against the upright-attitude valve seat 64d due to decompression in the cylinder part 21 acting through the relay port 64c during the inverted attitude of the discharge device 10, making it possible to smoothly introduce the content liquid in the container main body W into the cylinder part 21.

Since the channel forming member 65 provided with the common channel 68 that communicates with the content liquid inlet 21f and the relay port 64c includes the plug (topped tubular portion) 65b and the portion inside the plug 65b located above the inverted-attitude inlet 65a is the escape recess 69 into which the first switching valve 61 enters during the inverted attitude of the discharge device 10, it is possible to obtain the unit 1 for upright and inverted attitudes capable of allowing the content liquid in the container main body W to be smoothly introduced into the cylinder part 21 while minimizing the complexity of the structure.

Since at least one prevention part of the prevention part 75 configured to prevent the second switching valve 62 from entering the first path L1 during the upright attitude of the discharge device 10, and the prevention part configured to prevent the first switching valve 61 from entering the second path L2 during the inverted attitude of the discharge device 10 is provided, when the content liquid in the container main body W is introduced into the content liquid inlet 21f, it is possible to do at least one of the preventing the content liquid flowing through the first path L1 from coming into contact with the second switching valve 62, the second switching valve 62 from riding the liquid flow of the content liquid and approaching the inverted-attitude valve seat 64e, during the upright attitude of the discharge device 10, and the preventing the content liquid flowing through the second path L2 from coming into contact with the first switching valve 61, the first switching valve 61 from riding the liquid flow of the content liquid and approaching the upright-attitude valve seat 64d, during the inverted attitude of the discharge device 10.

Accordingly, when the content liquid is introduced into the content liquid inlet 21f, it is possible to do at least one of the preventing the second switching valve 62 from being pressed against the inverted-attitude valve seat 64e due to decompression in the cylinder part 21 exerted through the relay port 64c during the upright attitude of the discharge device 10, and the preventing the first switching valve 61 from being pressed against the upright-attitude valve seat 64d due to decompression in the cylinder part 21 exerted through the relay port 64c during the inverted attitude of the discharge device 10, making it possible to the content liquid in the container main body W from being smoothly introduced into the cylinder part 21.

Since the side opening 51a that communicates with the upright-attitude inlet 63a and the inside of the outer tube member 63 is formed in the circumferential wall of the covering portion 51 and the prevention part 75 protrudes upward from the top wall of the covering portion 51, during the upright attitude of the discharge device 10, by positioning the second switching valve 62 in the space surrounded by the back surface of the prevention part 75, the upper surface of the top wall of the covering portion 51 and the inner circumferential surface of the outer tube member 63, the second switching valve 62 can be reliably prevented from entering the first path L1.

The guide portion 52 is provided on the inside of the outer tube member 63, which guides the second switching valve 62, which attempts to enter the inlet portion of the first path L1 during the upright attitude of the discharge device 10, to the back surface side of the prevention part 75, so that the second switching valve 62 can be reliably prevented from entering the first path L1.

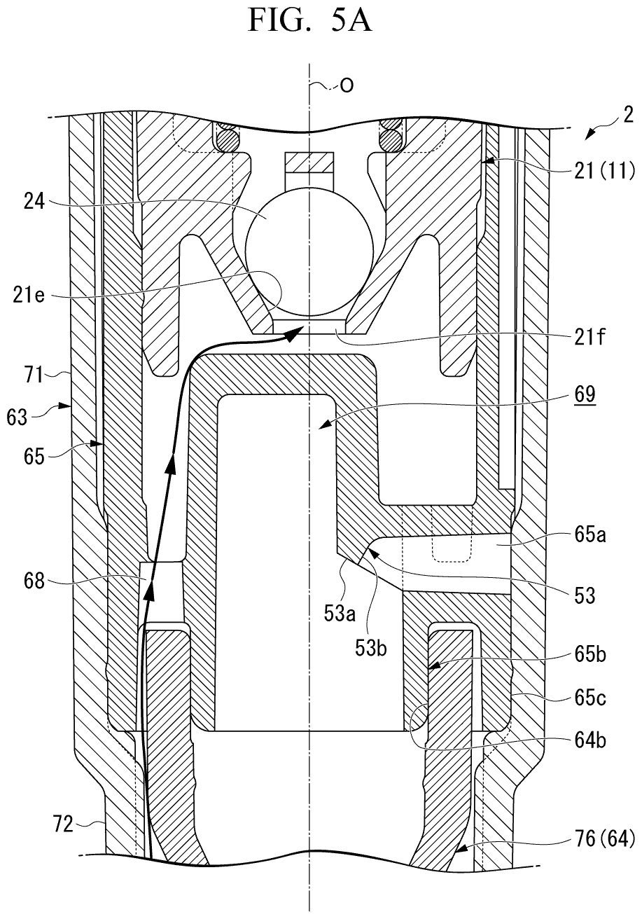

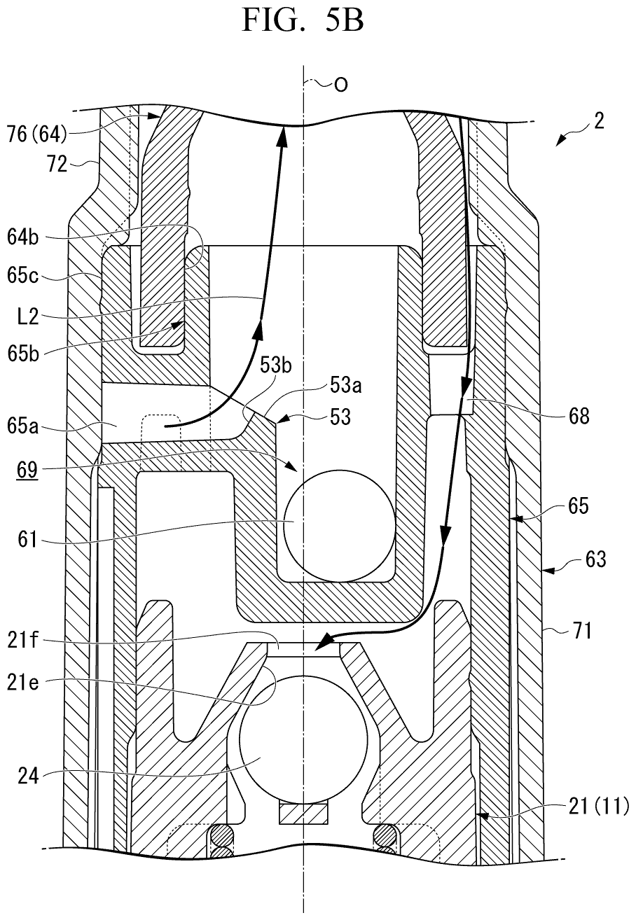

Next, a unit 2 for upright and inverted attitudes according to a second embodiment of the present invention will be described with reference to FIG. 5A and FIG. 5B.

Further, in the second embodiment, the same parts as the components in the first embodiment are designated by the same reference numerals, and description thereof will be omitted and only different points will be described.

At least one inlet of the upright-attitude inlet 63a and the inverted-attitude inlet 65a is provided with an introduction protrusion 53, the introduction protrusion 53 extending along the path of the content liquid from the inlet toward the relay port 64c, and having an introduction surface 53b facing inward of the inlet along the opening direction of the inlet.

A lower edge (tip edge) 53a of the introduction protrusion 53 facing the side of the relay port 64c along the path extends in a direction away from the relay port 64c as it goes toward the outer side of the inlet in the opening direction of the upright-attitude inlet 63a or the inverted-attitude inlet 65a which is provided with the introduction protrusion 53 when seen in a longitudinal cross-sectional view. A tilt angle of the lower edge 53a of the introduction protrusion 53 is 15° or more and 40° or less when seen in a longitudinal cross-sectional view in the opening direction. The introduction protrusion 53 is located on the outer side of the inlet in the opening direction with respect to a surface facing a surface provided with the introduction protrusion 53, in the upright-attitude inlet 63a or the inverted-attitude inlet 65a which is provided with the introduction protrusion 53. An end portion of the facing surface of the upright-attitude inlet 63a or the inverted-attitude inlet 65a which is provided with the introduction protrusion 53, the end portion being on a side of the introduction protrusion 53 in the opening direction, is located on an extension line of the lower edge 53a of the introduction protrusion 53 when seen in a longitudinal cross-sectional view in the opening direction.

In the example shown, the escape recess 69 is provided for the first switching valve 61, and the introduction protrusion 53 is provided in the inverted-attitude inlet 65a extending in the radial direction. The introduction protrusion 53 protrudes downward from a portion, that is located on the upper end and facing downward, of the inner end portion of the inner surface of the inverted-attitude inlet 65a in the radial direction. The introduction surface 53b extends along the second path L2 and faces outward in the radial direction. The introduction surface 53b extends inward in the radial direction as it goes downward. An inner surface of the introduction protrusion 53, which faces inward in the radial direction, extends straight in the upward/downward direction and is seamlessly connected to the inner surface of the escape recess 69 in the upward/downward direction. The lower edge 53a of the introduction protrusion 53 extends upward as it goes inward in the radial direction. When seen in a longitudinal cross-sectional view in the upward/downward direction and in the opening direction of the inverted-attitude inlet 65a, the tilt angle of the lower edge 53a of the introduction protrusion 53 with respect to the horizontal direction perpendicular to the axis O is, for example, 15° or more and 40° or less, preferably 25° or more and 35° or less (in the example shown, 30°). The introduction protrusion 53 is located radially inward from the lower end portion (facing surface) of the inner surface of the inverted-attitude inlet 65a. The lower edge 53a of the introduction protrusion 53 is located above the lower end portion of the inner surface of the inverted-attitude inlet 65a. When seen in a longitudinal cross-sectional view in the upward/downward direction and the opening direction of the inverted-attitude inlet 65a, an inner end portion of the inner surface of the inverted-attitude inlet 65a in the radial direction of the lower end portion (an end portion on the side of the introduction protrusion 53 in the opening direction) is located on an extension line of the lower edge 53a of the introduction protrusion 53.

A portion of the circumferential wall of the plug 65b located directly above the inverted-attitude inlet 65a protrudes inward in the radial direction more than a portion located directly below the inverted-attitude inlet 65a, and an inner end portion of the inverted-attitude inlet 65a in the radial direction is open downward toward the relay port 64c.

As described above, according to the unit 2 for upright and inverted attitudes of the embodiment, since the introduction protrusion 53 is provided in the inverted-attitude inlet 65a, when the content liquid passes through the inverted-attitude inlet 65a, the content liquid flows along the introduction surface 53b and is guided to the relay port 64c, thereby preventing it from flowing into the escape recess 69, and the liquid flow of the content liquid that passes through the inverted-attitude inlet 65a and flows into the escape recess 69 can prevent the first switching valve 61 in the escape recess 69 from floating up toward the relay port 64c. Accordingly, when the content liquid is introduced into the content liquid inlet 21f of the cylinder part 21, during the inverted attitude of the discharge device 10, it is possible to reliably prevent the first switching valve 61 from being pressed against the upright-attitude valve seat 64d due to the decompression in the cylinder part 21 exerted through the relay port 64c.

The lower edge 53a of the introduction protrusion 53 extends upward as it goes inward in the radial direction, the tilt angle of the lower edge 53a of the introduction protrusion 53 with respect to the horizontal direction perpendicular to the axis O is 15° or more and 40° or less when seen in a longitudinal cross-sectional view, the introduction protrusion 53 is located inward in the radial direction from the lower end portion on the inner surface of the inverted-attitude inlet 65a, and the inner end portion in the radial direction of the lower end portion on the inner surface of the inverted-attitude inlet 65a is located on the extension line of the lower edge 53a of the introduction protrusion 53 when seen in a longitudinal cross-sectional view.

Accordingly, the introduction protrusion 53 can be easily molded by cutting without complicating the structure of the molding tool.

For example, the upright-attitude inlet 63a may be configured to penetrate the third outer tube portion 73 in the radial direction, and a portion of the third outer tube portion 73 located below the upright-attitude inlet 63a may be used as an escape recess for the second switching valve 62, and the introduction protrusion 53 may be provided in the upright-attitude inlet 63a.

In this case, when the content liquid passes through the upright-attitude inlet 63a, the content liquid flows along the introduction surface 53b and is guided to the relay port 64c, thereby preventing it from flowing into the escape recess, and the liquid flow of the content liquid that has flowed through the upright-attitude inlet 63a into the escape recess can prevent the second switching valve 62 in the escape recess from floating up toward the relay port 64c. Accordingly, when the content liquid is introduced into the content liquid inlet 21f of the cylinder part 21, during the upright attitude of the discharge device 10, it is possible to reliably prevent the second switching valve 62 from being pressed against the inverted-attitude valve seat 64e due to the decompression in the cylinder part 21 exerted through the relay port 64c.

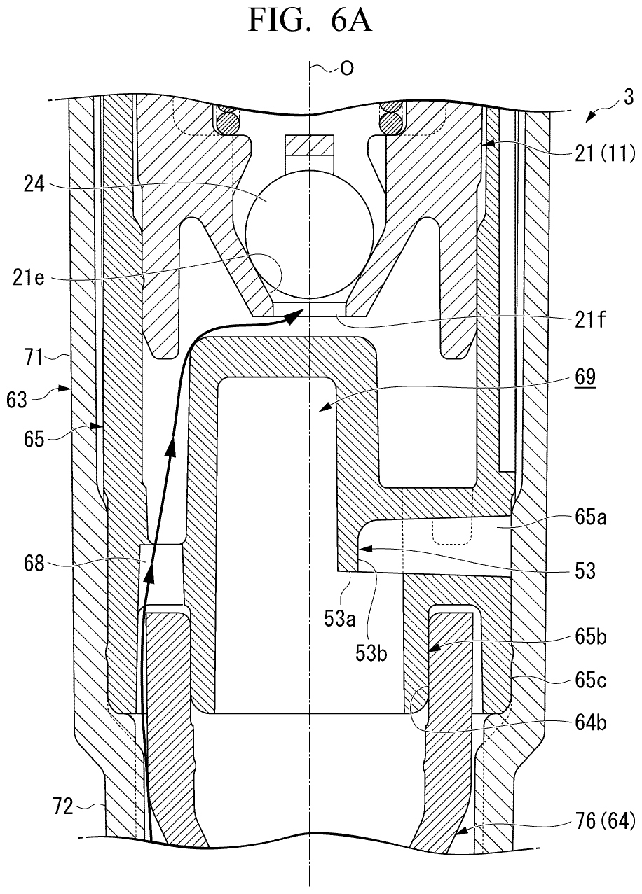

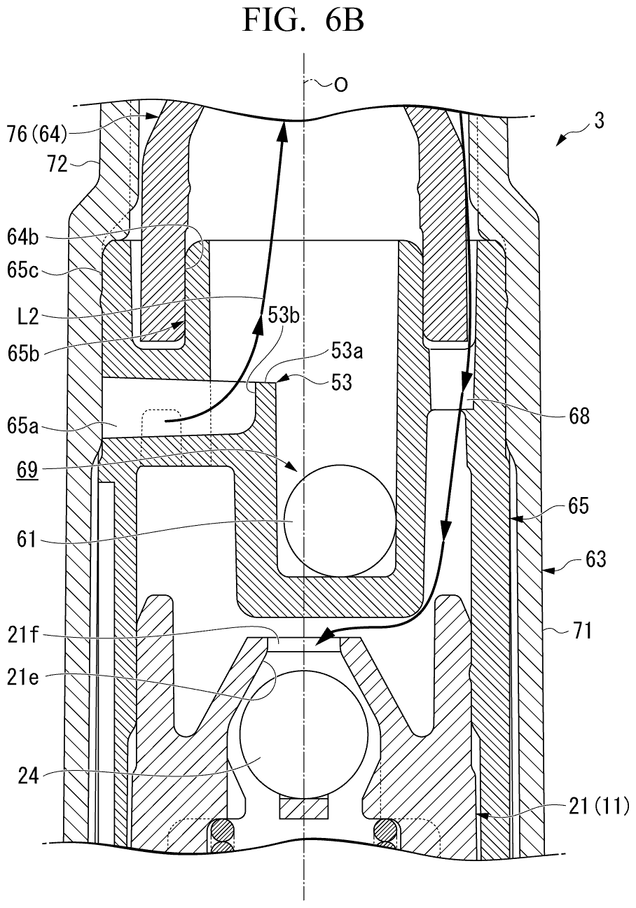

Next, a unit 3 for upright and inverted attitudes according to a third embodiment of the present invention will be described with reference to FIG. 6A and FIG. 6B.

Further, in the third embodiment, the same parts as the components in the second embodiment are designated by the same reference numerals, and description thereof will be omitted and only different points will be described.

In the unit 3 for upright and inverted attitudes of the embodiment, the introduction surface 53b of the introduction protrusion 53 extends straight in the upward/downward direction. The lower edge 53a of the introduction protrusion 53 is tilted 3° in the same direction as the second embodiment when seen in a longitudinal cross-sectional view in the upward/downward direction. When seen in a longitudinal cross-sectional view, the inner end portion in the radial direction of the lower end portion on the inner surface of the inverted-attitude inlet 65a is located on the extension line of the lower edge 53a of the introduction protrusion 53.

As described above, according to the unit 3 for upright and inverted attitudes of the embodiment, since the introduction surface 53b of the introduction protrusion 53 extends straight in the upward/downward direction, when the content liquid passes through the inverted-attitude inlet 65a, it is possible to reliably suppress the content liquid from flowing into the escape recess 69.

Further, the technical scope of the present invention is not limited to the above-mentioned embodiment, and various modifications may be made without departing from the spirit of the present invention.

The covering portion 51 and the guide portion 52 may not be provided inside the outer tube member 63.

The prevention part with respect to the first switching valve 61 and the prevention part 75 with respect to the second switching valve 62 may not be provided.

A configuration in which a topped tubular shape extending throughout the entire circumference and disposed coaxially with the axis O may be employed as the covering portion 51, a plurality of side openings 51a may be formed at intervals in the circumferential wall of the covering portion 51 in the circumferential direction, and a configuration in which a tubular shape continuously extending throughout the entire circumference and disposed on the outer circumferential edge portion of the top wall of the covering portion 51 coaxially with the axis O may be employed as the prevention part 75 with respect to the second switching valve 62. In this configuration, the second switching valve 62 is located on the upper surface of the top wall of the covering portion 51 inside the prevention part 75 and disposed on the axis O.

In this case, during the inverted attitude of the discharge device 10, it is possible to easily locate the second switching valve 62 in close contact with the inverted-attitude valve seat 64e.

In addition, the components in the embodiments may be replaced with well-known components as appropriate without departing from the spirit of the present invention, and the above-mentioned embodiments and variants may be combined as appropriate.

An aspect of the present invention is, for example, as follows.

<1>

A unit for upright and inverted attitudes attached to a cylinder part of a discharge device, the unit for upright and inverted attitudes including:
an upright-attitude inlet into which a content liquid in a container main body is able to be introduced into a content liquid inlet of the cylinder part during an upright attitude of the discharge device;
an inverted-attitude inlet into which the content liquid in the container main body is able to be introduced into the content liquid inlet during an inverted attitude of the discharge device;
a relay port that is able to communicate with the content liquid inlet, the upright-attitude inlet, and the inverted-attitude inlet;
a first switching valve abutting an upright-attitude valve seat and configured to cut off communication between the inverted-attitude inlet and the relay port during the upright attitude of the discharge device;
a second switching valve abutting an inverted-attitude valve seat and configured to cut off communication between the upright-attitude inlet and the relay port during the inverted attitude of the discharge device; and
at least one escape recess of an escape recess configured to allow the second switching valve to enter therein and separate the second switching valve from a first path of the content liquid from the upright-attitude inlet toward the relay port on a side opposite to the inverted-attitude valve seat and in a direction crossing an opening direction of the upright-attitude inlet during the upright attitude of the discharge device, and an escape recess configured to allow the first switching valve to enter therein and separate the first switching valve from a second path of the content liquid from the inverted-attitude inlet toward the relay port on a side opposite to the upright-attitude valve seat and in a direction crossing the opening direction of the inverted-attitude inlet during the inverted attitude of the discharge device.
   <2>

The unit for upright and inverted attitudes according to the <1>, further including:
a channel forming member provided with a common channel that communicates with the content liquid inlet and the relay port,
wherein the channel forming member includes a topped tubular portion extending in an upward/downward direction,
the inverted-attitude inlet and the relay port are communicating with respect to each other through an inside of the topped tubular portion,
the inverted-attitude inlet is formed in a portion of a circumferential wall of the topped tubular portion located below an upper end portion, and
a portion in the inside of the topped tubular portion and located above the inverted-attitude inlet is the escape recess into which the first switching valve enters during the inverted attitude of the discharge device.
   <3>

The unit for upright and inverted attitudes according to the <1> or <2>, further including at least one prevention part of a prevention part configured to prevent the second switching valve from entering the first path during the upright attitude of the discharge device, and a prevention part configured to prevent the first switching valve from entering the second path during the inverted attitude of the discharge device.

<4>

The unit for upright and inverted attitudes according to any one of the <1> to <3>, wherein at least one inlet of the upright-attitude inlet and the inverted-attitude inlet is provided with an introduction protrusion, the introduction protrusion extending along a path for a content liquid from the at least one inlet toward the relay port, and having an introduction surface facing inward of the at least one inlet in an opening direction of the at least one inlet.

<5>

The unit for upright and inverted attitudes according to the <4>, wherein a tip edge of the introduction protrusion facing the relay port along the path, extends in a direction away from the relay port as it goes toward an outside of the at least one inlet in the opening direction of the at least one inlet provided with the introduction protrusion when seen in a longitudinal cross-sectional view,
a tilt angle of the tip edge of the introduction protrusion is 15° or more and 40° or less when seen in a longitudinal cross-sectional view,
the introduction protrusion is located on the outside of the at least one inlet in the opening direction with respect to a surface facing a surface provided with the introduction protrusion, in the at least one inlet provided with the introduction protrusion, and
an end portion of the facing surface of the at least one inlet provided with the introduction protrusion, the end portion being on a side of the introduction protrusion in the opening direction, is located on an extension line of the tip edge of the introduction protrusion when seen in a longitudinal cross-sectional view.

### INDUSTRIAL APPLICABILITY

According to the present invention, it is possible to smoothly introduce a content liquid in a container main body in to a cylinder part.

### REFERENCE SIGNS LIST

1, 2, 3 Unit for upright and inverted attitudes
10 Discharge device
11 Pump
12 Discharge head
12c Discharge hole
21 Cylinder part
21f Content liquid inlet
51 Covering portion
51a Side opening
52 Guide portion
53 Introduction protrusion
53a Lower edge (tip edge)
61 First switching valve
62 Second switching valve
63 Outer tube member
63a Upright-attitude inlet
64c Relay port
64d Upright-attitude valve seat
64e Inverted-attitude valve seat
65 Channel forming member
65a Inverted-attitude inlet
65b Plug (topped tubular portion)
68 Common channel
69 Escape recess
75 Prevention part
L1 First path
L2 Second path
W Container main body
W1 Mouth portion

1. A unit for upright and inverted attitudes attached to a cylinder part of a discharge device, the unit for upright and inverted attitudes comprising:
an upright-attitude inlet into which a content liquid in a container main body is able to be introduced into a content liquid inlet of the cylinder part during an upright attitude of the discharging device;
an inverted-attitude inlet into which the content liquid in the container main body is able to be introduced into the content liquid inlet during an inverted attitude of the discharge device;
a relay port that is able to communicate with the content liquid inlet, the upright-attitude inlet, and the inverted-attitude inlet;
a first switching valve abutting an upright-attitude valve seat and configured to cut off communication between the inverted-attitude inlet and the relay port during the upright attitude of the discharge device;
a second switching valve abutting an inverted-attitude valve seat and configured to cut off communication between the upright-attitude inlet and the relay port during the inverted attitude of the discharge device; and
at least one escape recess of
an escape recess configured to allow the second switching valve to enter therein and separate the second switching valve from a first path of the content liquid from the upright-attitude inlet toward the relay port on a side opposite to the inverted-attitude valve seat and in a direction crossing an opening direction of the upright-attitude inlet during the upright attitude of the discharge device, and
an escape recess configured to allow the first switching valve to enter therein and separate the first switching valve from a second path of the content liquid from the inverted-attitude inlet toward the relay port on a side opposite to the upright-attitude valve seat and in a direction crossing the opening direction of the inverted-attitude inlet during the inverted attitude of the discharge device.

2. The unit for upright and inverted attitudes according to claim 1, further comprising:
a channel forming member provided with a common channel that communicates with the content liquid inlet and the relay port,
wherein the channel forming member includes a topped tubular portion extending in an upward/downward direction,
the inverted-attitude inlet and the relay port are communicating with respect to each other through an inside of the topped tubular portion,
the inverted-attitude inlet is formed in a portion of a circumferential wall of the topped tubular portion located below an upper end portion, and
a portion in the inside of the topped tubular portion and located above the inverted-attitude inlet is the escape recess into which the first switching valve enters during the inverted attitude of the discharge device.

3. The unit for upright and inverted attitudes according to claim 1, further comprising
at least one prevention part of
a prevention part configured to prevent the second switching valve from entering the first path during the upright attitude of the discharge device, and
a prevention part configured to prevent the first switching valve from entering the second path during the inverted attitude of the discharge device.

4. The unit for upright and inverted attitudes according to claim 1, wherein
at least one inlet of the upright-attitude inlet and the inverted-attitude inlet is provided with an introduction protrusion,
the introduction protrusion extending along a path for a content liquid from the at least one inlet toward the relay port, and having an introduction surface facing inward of the at least one inlet in an opening direction of the at least one inlet.

5. The unit for upright and inverted attitudes according to claim 4, wherein
a tip edge of the introduction protrusion facing the relay port along the path extends in a direction away from the relay port as it goes toward an outside of the at least one inlet in the opening direction of the at least one inlet provided with the introduction protrusion when seen in a longitudinal cross-sectional view,
a tilt angle of the tip edge of the introduction protrusion is 15° or more and 40° or less when seen in a longitudinal cross-sectional view,
the introduction protrusion is located on the outside of the at least one inlet in the opening direction with respect to a surface facing a surface provided with the introduction protrusion, in the at least one inlet provided with the introduction protrusion, and
an end portion of the facing surface of the at least one inlet provided with the introduction protrusion, the end portion being on a side of the introduction protrusion in the opening direction, is located on an extension line of the tip edge of the introduction protrusion when seen in a longitudinal cross-sectional view.

6. The unit for upright and inverted attitudes according to claim 2, further comprising
at least one prevention part of
a prevention part configured to prevent the second switching valve from entering the first path during the upright attitude of the discharge device, and
a prevention part configured to prevent the first switching valve from entering the second path during the inverted attitude of the discharge device.

7. The unit for upright and inverted attitudes according to claim 2, wherein
at least one inlet of the upright-attitude inlet and the inverted-attitude inlet is provided with an introduction protrusion,
the introduction protrusion extending along a path for a content liquid from the at least one inlet toward the relay port, and having an introduction surface facing inward of the at least one inlet in an opening direction of the at least one inlet.

8. The unit for upright and inverted attitudes according to claim 7, wherein
a tip edge of the introduction protrusion facing the relay port along the path extends in a direction away from the relay port as it goes toward an outside of the at least one inlet in the opening direction of the at least one inlet provided with the introduction protrusion when seen in a longitudinal cross-sectional view,
a tilt angle of the tip edge of the introduction protrusion is 15° or more and 40° or less when seen in a longitudinal cross-sectional view,
the introduction protrusion is located on the outside of the at least one inlet in the opening direction with respect to a surface facing a surface provided with the introduction protrusion, in the at least one inlet provided with the introduction protrusion, and
an end portion of the facing surface of the at least one inlet provided with the introduction protrusion, the end portion being on a side of the introduction protrusion in the opening direction, is located on an extension line of the tip edge of the introduction protrusion when seen in a longitudinal cross-sectional view.
